(19) United States
(12) Patent Application Publication
(10) Pub. No.: US 2015/0012679 A1
(43) Pub. Date: Jan. 8, 2015

(54) IMPLEMENTING REMOTE TRANSACTION FUNCTIONALITIES BETWEEN DATA PROCESSING NODES OF A SWITCHED INTERCONNECT FABRIC

(71) Applicant: III Holdings 2, LLC, Wilmington, DE (US)

(72) Inventors: Mark Bradley Davis, Austin, TX (US); Prashant R. Chandra, San Jose, CA (US); Thomas A. Volpe, Austin, TX (US)

(21) Appl. No.: 13/935,108

(22) Filed: Jul. 3, 2013

(51) Int. Cl. G06F 13/364

(52) U.S. Cl. CPC G06F 13/364
USPC 710/110

(57) ABSTRACT

A method of implementing remote transactions between system on a chip (SoC) nodes of a node interconnect fabric includes determining that a bus transaction initiated at a first one of the SoC nodes specifies a target at a second one of the SoC nodes, providing a virtual on-chip bus between the first and second SoC nodes within the fabric, and providing the bus transaction to the second one of the SoC nodes over the virtual link on-chip bus.

### BACKGROUND

1. Field of the Invention

Embodiments of the present invention relate to a switched interconnect fabric and nodes thereof. More specifically, embodiments of the present invention relate to implementation of remote transaction functionalities between nodes of a switched interconnect fabric such as a cluster of fabric-attached Server on a Chip (SoC) nodes.

2. Description of Related Art

Ethernet fabric topology provides a higher level of performance, utilization, availability and simplicity than conventional Ethernet network system architecture that employ a spanning tree type of topology. Such Ethernet fabric topologies are flatter and self-aggregating in part because of the use of intelligent switches in the fabric that are aware of the other switches and can find shortest paths without loops. Furthermore, Ethernet fabric topologies are scalable with high performance and reliability. Ethernet fabric data center architectures are commercially available from entities such as, for example, Juniper, Avaya, Brocade, and Cisco.

A “shared nothing architecture” is a distributed computing architecture in which each node is independent and self-sufficient. A shared nothing architecture is popular for web development and deployment because of its scalability. Typically, none of the nodes in a cluster of nodes having a shared nothing architecture directly share memory or disk storage. A SoC node is an example of a data processing node that is configured in accordance with a shared nothing architecture and that can be deployed using an Ethernet fabric topology.

It is well known that a significant deficiency of data processing nodes having a shared nothing architecture is their limited ability to allow transaction functionalities to be implemented between data processing nodes of the cluster (i.e., remote transaction functionalities). Examples of such remote transaction functionalities include, but are not limited to, remote memory transactions, remote I/O transactions, remote interrupt transactions and remote direct memory access (DMA) transactions. Accordingly, implementation of remote transaction functionalities between data processing nodes having a shared nothing architecture and particularly those deployed using an Ethernet fabric topology would be advantageous, useful and desirable.

### SUMMARY

Embodiments of the present invention are directed to implementation of remote transaction functionalities between data processing nodes (e.g., Server on a Chip (SoC) nodes) of a fabric (e.g., a switched interconnect fabric). More specifically, embodiments of the present invention are directed to implementation of remote transaction functionalities between data processing nodes (e.g., SoC nodes) having a shared nothing architecture and particularly those deployed using an Ethernet fabric topology. To this end, data processing nodes configured in accordance with the present invention can advantageously provide for remote transaction based functionalities such as remote memory transactions, remote I/O transactions, remote interrupt transactions and remote direct memory access (DMA) transactions in a manner not possible with data processing nodes having a shared nothing architecture.

In one embodiment, an inter-node messaging module of a system on a chip (SoC) node comprises an on-chip bus slave interface, an on-chip bus master interface and a remote transaction engine. The remote transaction engine is coupled to the on-chip bus slave interface for enabling receipt of a bus transaction from a bus transaction initiator of the SoC node and to the on-chip bus master interface for enabling transmission of a bus transaction to a bus transaction target of the SoC node. The remote transaction engine translates bus interface signals representing a bus transaction received on the on-chip bus slave interface to at least one packet having a fabric protocol format and imparts at least one packet with a fabric global address derived from and corresponding to a target address specified in the bus transaction received on the on-chip bus slave interface.

In another embodiment, a method of implementing remote transactions between system on a chip (SoC) nodes of a node interconnect fabric comprises determining that a bus transaction initiated at a first one of the SoC nodes specifies a target at a second one of the SoC nodes, providing a virtual on-chip bus between the first and second SoC nodes within the fabric, and providing the bus transaction to the second one of the SoC nodes over the virtual on-chip bus.

In another embodiment, a system on a chip (SoC) node comprises a cache coherent interconnect, a bus transaction initiator coupled to the cache coherent interconnect, a bus transaction target coupled to the cache coherent interconnect, an on-chip bus switch connected to the cache coherent interconnect and an inter-node messaging module. The inter-node messaging module has an on-chip bus slave interface, an on-chip bus switch master interface, a node interconnect fabric interface and a remote transaction engine. The on-chip bus slave interface and the on-chip bus switch master interface are each coupled between the on-chip bus switch and the remote transaction engine. The on-chip bus switch determines if a target of a bus transaction issued from the bus transaction initiator is local to the SoC node or remote from the SoC node. The remote transaction engine receives the bus transaction issued from the bus transaction initiator on the on-chip bus slave interface when the on-chip bus switch determines that the bus transaction issued from the bus transaction initiator has a target at a different SoC node, translates bus interface signals representing the bus transaction issued from the bus transaction initiator to at least one packet having a fabric protocol format and imparts the at least one packet with a fabric global address derived from and corresponding to a target address specified in the bus transaction issued from the bus transaction initiator. The remote transaction engine maps a bus transaction identifier of a bus transaction received on the node interconnect fabric interface to a respective local bus transaction identifier and then issues the bus transaction received on the node interconnect fabric interface on the on-chip bus master interface using the respective local bus transaction identifier.

In another embodiment, a data processing system comprises a node interconnect fabric, a first system on a chip (SoC) node and a second SoC node. The first SoC node includes a first inter-node messaging module having an on-chip bus slave interface, a first node interconnect fabric interface and a first remote transaction engine. The first SoC node is coupled to the node interconnect fabric through the first node interconnect fabric interface. The first remote transaction engine receives a bus transaction on the on-chip bus slave interface when it is determined that the bus transaction specifies a target that is not local to the first SoC node, translates the bus interface signals representing the bus transaction to at least one packet having a fabric protocol format, imparts the at least one packet with a fabric global address derived from and corresponding to a target address specified in the bus transaction, and causes the at least one packet to be transmitted for reception by the target through the node interconnect fabric via the first node interconnect fabric interface. The second SoC node includes a second inter-node messaging module having an on-chip bus switch master interface, a second node interconnect fabric interface and a second remote transaction engine. The second SoC node includes the target specified in the bus transaction and is coupled to the node interconnect fabric through the second node interconnect fabric interface for allowing the at least one packet to be received by the second SoC node. The second remote transaction engine extracts the bus transaction from the at least one packet, maps a bus transaction identifier of the bus transaction to a respective local bus transaction identifier and then issues the bus transaction on the on-chip bus master interface using the respective local bus transaction identifier.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a diagrammatic view showing a data processing system (i.e., data processing node cluster) configured in accordance with an embodiment of the present invention for implementing remote bus transaction functionality.

FIG. 2 is a diagrammatic view showing a manner in which remote AXI transactions are communicated over a virtual on-chip link within a fabric between initiator and target nodes of the data processing system of FIG. 1.

FIG. 3 is a block diagram of a data processing node configured in accordance with an embodiment of the present invention that serves in the capacity as an initiator node and as a target node with respect to remote transaction functionality.

FIG. 4 is a flow diagram showing a method in accordance with an embodiment of the present invention for implementing remote transactions between SoC nodes of a node interconnect fabric.

FIG. 5 is a diagrammatic view showing a data processing system configured for implementing the method of FIG. 4.

FIG. 6 is a block diagram showing an address map configured in accordance with an embodiment of the present invention.

FIG. 7 is a diagrammatic view showing a remote memory address look-up table configured in accordance with an embodiment of the present invention.

FIG. 8 is a diagrammatic view showing a remote I/O address look-up table configured in accordance with an embodiment of the present invention.

FIG. 9 is a diagrammatic view showing a bus transaction identifier mapping table configured in accordance with an embodiment of the present invention.

FIG. 10 is a diagrammatic view showing a Remote Interrupt Distributor (RID) logic block that provides remote interrupt controller functionality in accordance with an embodiment of the present invention.

### DETAILED DESCRIPTION

Embodiments of the present invention are directed to implementation of remote transaction functionalities between a pluralities of data processing nodes in a network. Examples of remote transaction functionalities include, but are not limited to, remote load/store memory transactions, remote I/O transactions and remote interrupt transactions. Remote transactions must be clearly distinguished from send/recv message passing transactions and rely on the concept of a shared global fabric address space that can be accessed by standard CPU loads and stores or by DMA operations initiated by I/O controllers. Server on a chip (SoC) nodes that are interconnected within a fabric via a respective fabric switch are examples of a data processing node in the context of the present invention. In this regard, a transaction layer (e.g., integrated between Ethernet, RDMA, and transport layers) of a SoC node configured in accordance with an embodiment of the present invention enables implementation of remote memory transactions, remote I/O transactions, remote interrupt transactions and remote direct memory access (DMA) transactions. However, the present invention is not unnecessarily limited to any particular type, configuration, or application of data processing node.

Advantageously, data processing nodes configured in accordance with the present invention are configured for implementing remote bus transaction functionality. Remote bus transaction functionality refers to the tunneling of on-chip bus transactions (e.g., AXI4 bus transactions) across the fabric. With remote bus transaction functionality, an on-chip bus master (e.g., an AXI4 master such as a CPU or DMA) in one node (i.e., an initiator node) may issue transactions targeted at an on-chip bus transaction slave (e.g., an AXI4 slave such as a DRAM memory controller) in another node (e.g., a target node).

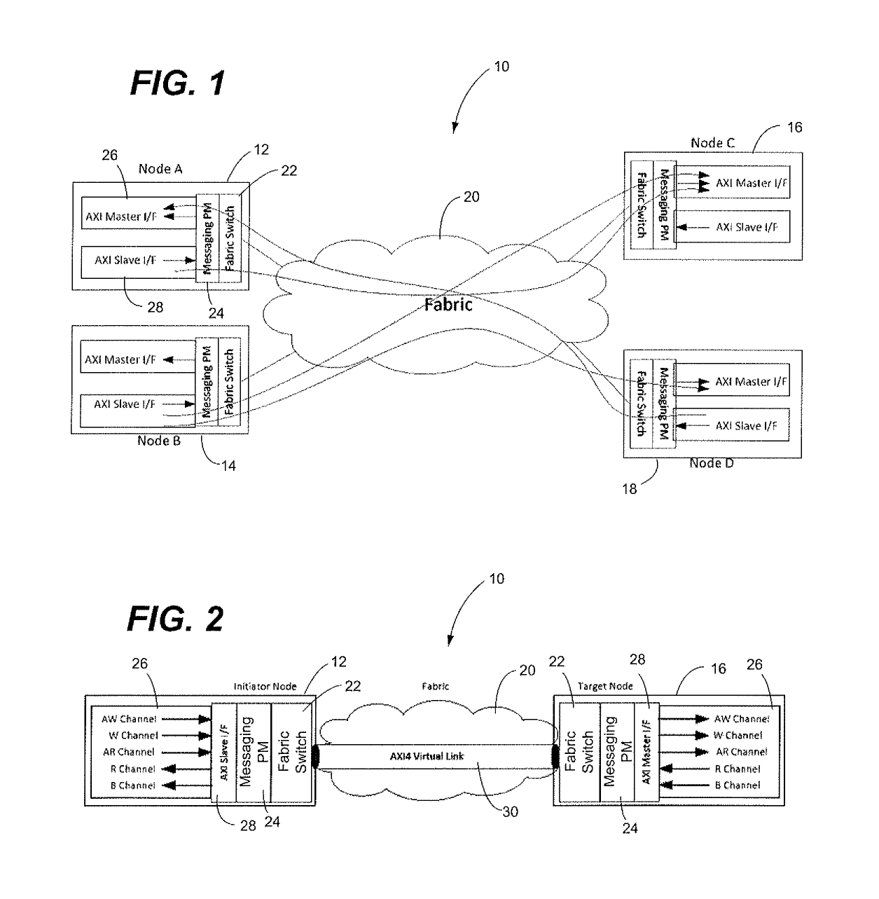

FIG. 1 shows a data processing system 10 (i.e., data processing node cluster) configured in accordance with an embodiment of the present invention for implementing remote bus transaction functionality. The data processing system 10 includes a plurality of data processing nodes (e.g., a first data processing node 12, a second data processing node 14, a third data processing node 16 and a fourth data processing node 18). Each one of the data processing nodes 12-18 is coupled to a node interconnects fabric 20 (i.e., the fabric 20) through a fabric switch 22 thereof.

In certain embodiments, a preferred protocol for an on-chip bus of the nodes 12-18 is configured in accordance with AXI4 (Advanced Extensible Interface 4) bus interface specification (i.e., remote AXI functionality). AXI4 is the fourth generation of the Advanced Microcontroller Bus Architecture (AMBA) interface protocol of ARM Limited. However, as a skilled person will appreciate in view of the disclosures made herein, the present invention is not unnecessarily limited to a particular on-chip bus protocol.

As shown in FIG. 1, AXI4 masters and slaves can be distributed across different data processing nodes in the data processing system 10. In this regard, multiple AXI4 masters can connect to multiple AXI4 slaves without the limitation that such AXI masters and slaves are within a common data processing node. From an architectural perspective, the fabric 20 together with the set of connected AXI4 master and slave interfaces of each one of the data processing nodes 12-18 can be viewed as a conventional AXI network interconnect. AXI4 master interfaces refer to AXI4-configured bus interfaces directed away from a respective node I/O master and AXI4 slave interfaces refer to AXI-4 configured bus interfaces directed into a node I/O master.

Remote bus transaction functionality is implemented in a Messaging Personality Module (messaging PM) 24. The messaging PM 24 is a hardware interface that is sometimes also referred to herein as an inter-node messaging module as it enables messaging between interconnected nodes. The messaging PM 24 has an AXI4 master interface 26 and an AXI4 slave interface 28 connected to a bus interconnect structure such as a cache coherent interconnect. A remote AXI transaction (i.e., a bus transaction) is received over the AXI4 slave interface 28 on the messaging PM 24 of a first one of the data processing nodes (e.g., initiator node 12) and is tunneled across the fabric 20 to a second one of the data processing nodes (e.g., target node 16). In certain embodiments, tunneling of the remote AXI transaction (i.e., AXI4 tunneling) uses a reliable connection (RC) mode of the node transport layer to provide data integrity and reliable delivery of AXI transactions flowing across the fabric 20. Once at the second one of the data processing nodes, the remote AXI transaction is issued on the AXI4 master interface 26 of the second one of the data processing nodes. As discussed below in greater detail, the messaging PM 24 of the first one of the data processing nodes and the messaging PM of the second one of the data processing nodes must jointly implement the necessary logic for implementing the AXI tunneling.

FIG. 2 shows a manner in which remote AXI transactions are communicated over a virtual AXI4 (i.e., on-chip) link 30 within the fabric 20 between the initiator node 12 and the target node 16. The virtual AXI4 link can be provided between the messaging PM 24 on the initiator node 12 and the messaging PM 24 on the target node 16 using a transport layer reliable connection across the fabric 20. In this regard, the virtual AXI4 link 30 can be thought of as replacing physical wires (i.e., a link) on which AXI bus signal traditionally run within a SoC with a “virtual link” that becomes effectively a virtual bus bridge across fabric 20.

A remote AXI transaction is received over the AXI4 slave interface 28 on the messaging PM 24 of the initiator node 12 and is tunneled across the fabric 20 via the virtual AXI4 link 30 to the target node 16. The tunneling can be implemented using fine grain cacheline transfers such that initiator node bus transactions to target node remote resources (e.g., CPU loads and stores of an initiator node to memory locations of a target node) on the virtual AXI4 link 30 across the fabric 20 occur on a cache line granularity. As will be discussed below in greater detail, to communicate a AXI4 bus transaction between the AXI slave interface of the initiator node 12 and the AXI master interface 26 of the target node, the AXI4 bus signals representing the AXI4 bus transaction are directed to the messaging PM 24 of the initiator node 12 when it is determined that the bus transaction required resources that are not local to the initiator node 12 and, subsequently, these AXI4 bus signals are packetized by the messaging PM 24 of the initiator node 12 and are then transferred across the fabric 20 from the initiator node 12 to the target node 16 via the virtual AXI4 link 30. The messaging PM 24 of the target node 16 then processes the incoming packet (i.e., transaction layer packet(s)) and issues (e.g., replay/reproduces) the AXI4 bus transaction though the AXI master interface 26 of the target node 16.

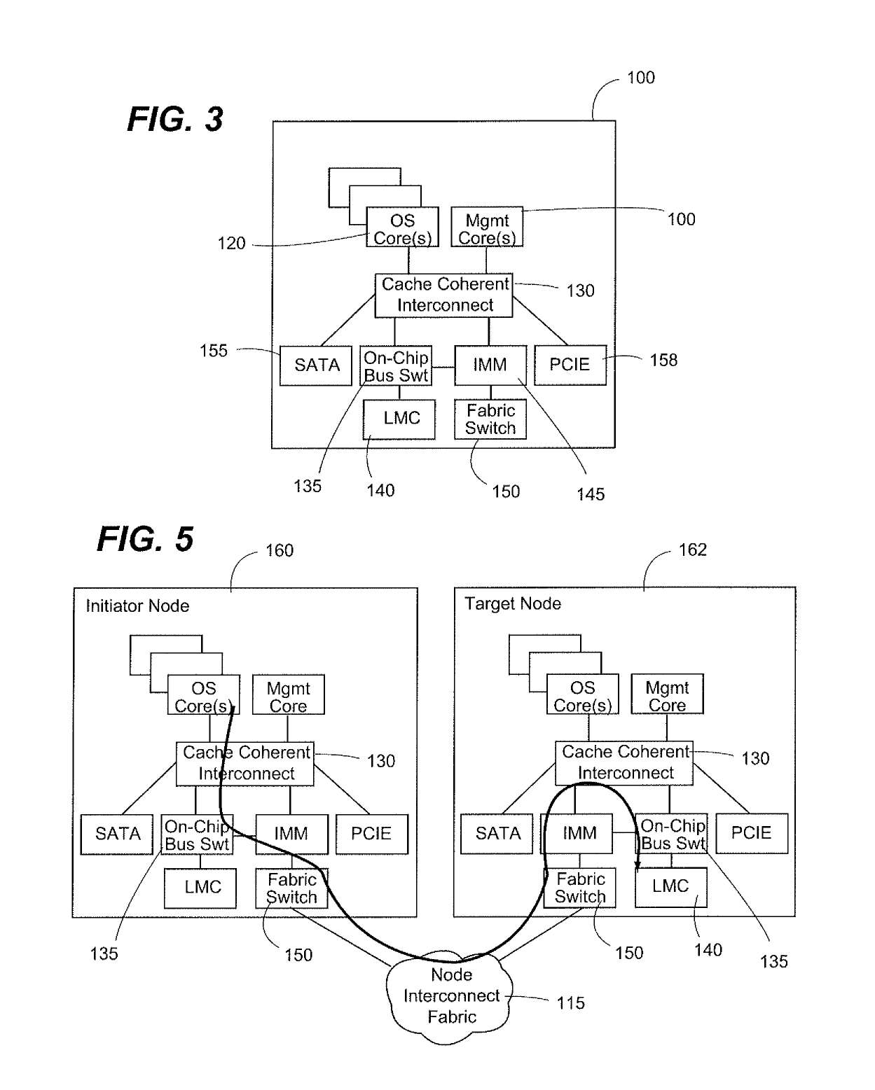

FIG. 3 shows a data processing node 100 that can serve in the capacity as an initiator node (e.g., the initiator node 12 of FIGS. 1 and 2) and as a target node (e.g., the target node 16 of FIGS. 1 and 2). In this regard, in preferred embodiments of the present invention, initiator nodes and target nodes are similarly if not identically configured. A SoC node (i.e., SoC) is an example of the data processing node 100.

The data processing node 100 includes a plurality of OS cores 120 (or a single OS core), a management core 125 (or a plurality of management cores), a cache coherent interconnect 130, an on-chip bus switch 135, a local memory controller 140, an inter-node messaging module 145, a fabric switch 150, a SATA (serial advanced technology attachment) interface 155 and a PCIe (Peripheral Componenet Interconnect Express) interface 158. The cache coherent interconnect 130 is coupled between the OS cores 120, the management core 125, the on-chip bus switch 135, the inter-node messaging module 145, the SATA interface 155 and the PCIe interface 158. The on-chip bus switch 135 is coupled between the local memory controller 140 and the inter-node messaging module 145. The inter-node messaging module 145 (also referred to as messaging PM) is a hardware interface coupled between the local memory controller 140 and the on-chip bus switch 135 for enabling remote transaction functionality. In this regard, the inter-node messaging module 145 can include a portion specifically configured for providing remote transaction functionality (i.e., a remote transaction engine thereof) and other portions for providing functionality not directly related to remote transaction functionality. In certain embodiments, a preferred protocol for an on-chip bus of the data processing node 100 is configured in accordance with AXI4 bus interface specification.

The various elements of the data processing node 100 are communicatively coupled to each via master and/or slave on-chip bus switch interfaces. The inter-node messaging module 145 as well as the SATA interface 155 and the PCIe interface 158 connect to the cache coherent interconnect 130 through both on-chip bus master and slave interfaces. The OS cores 120 and the management core 125 connect to the cache coherent interconnect 130 through on-chip bus master interfaces. The on-chip bus switch 135 is coupled between the cache coherent interconnect 130, the inter-node messaging module 145, and the local memory controller 140 through on-chip bus master interfaces. On-chip bus master interfaces refer to bus interfaces directed from a respective node I/O master (e.g., the OS cores 120, the management core 125, the inter-node messaging module 145, the SATA interface 155 and the PCIe interface 158) toward the cache coherent interconnect 130 and on-chip bus slave interfaces refer to bus interfaces directed from the cache coherent interconnect 130 toward a respective node I/O master.

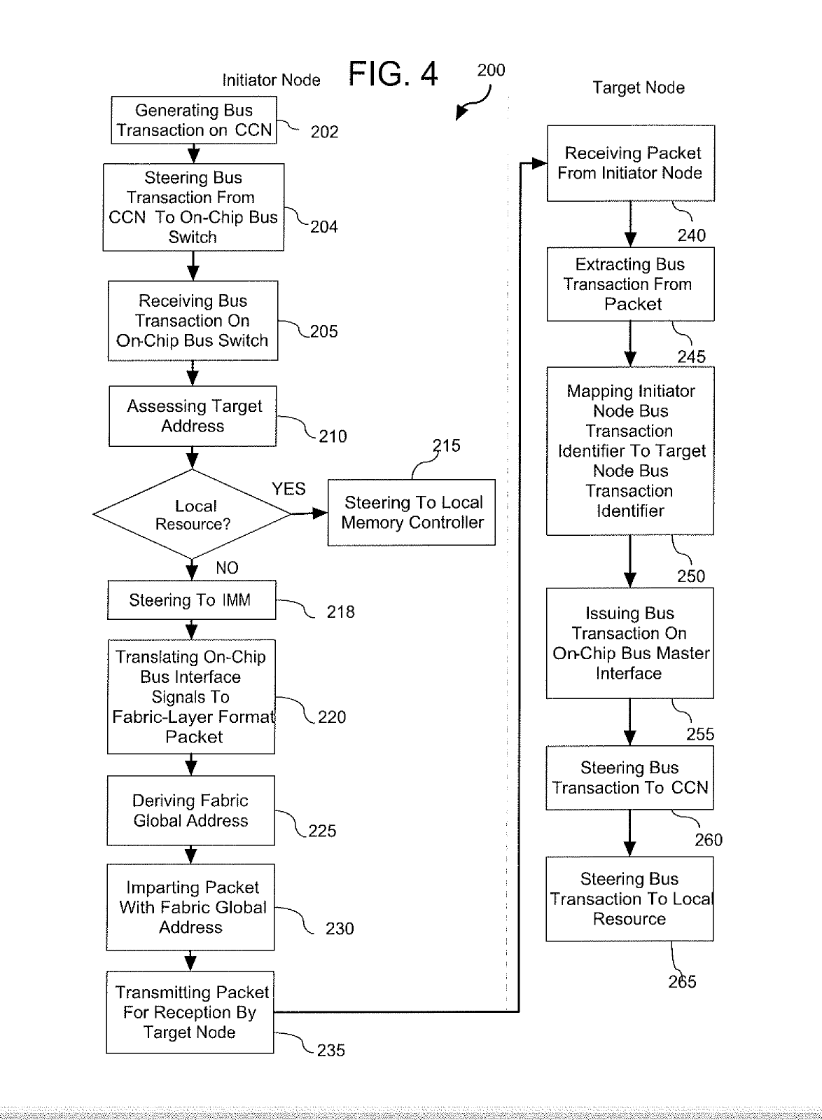

Turning now to FIGS. 4 and 5, a method 200 in accordance with an embodiment of the present invention for implementing remote transactions between SoC nodes of a node interconnect fabric is shown. The method 200 can be implemented within a data processing node cluster such as the data processing system 10 disclosed above in reference to FIGS. 1 and 2 and can be implemented in data processing nodes such as the data processing node 100 discussed above in reference to FIG. 3. Accordingly, as shown in FIG. 5, the ensuing discussion on the method 200 will be described in the context of reference numerals be presented above in association with the various elements of the data processing node 100.

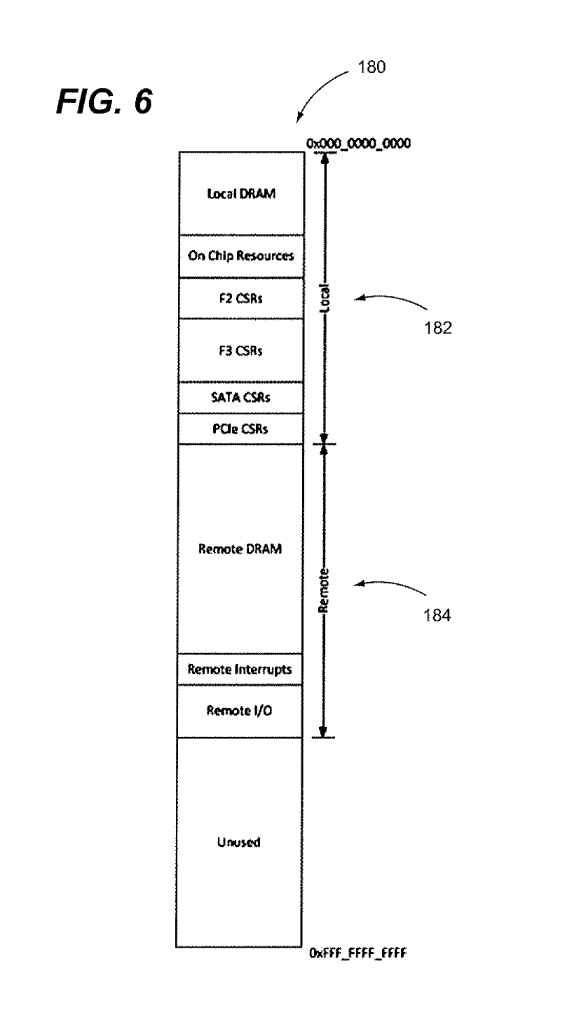

Referring to FIGS. 4 and 5, the method 200 begins at an initiator 160 node with an operation 202 being performed for generating a bus transaction on the cache coherent interconnect 130, followed by an operation 204 being performed for steering the bus transaction to the on-chip bus switch 135 by the cache coherent interconnect 130. Thereafter, an operation 205 being performed for receiving the bus transaction on the on-chip bus switch 135 of the initiator node 160 from the cache coherent interconnect 130. For example, an OS core 120 of the initiator node 160 can generate a load or store instruction to memory in a remote DRAM region of a local address space, translate that load instruction into a load bus transaction (e.g., an AXI4 bus transaction) and then issue into the cache coherent interconnect 130. FIG. 6 shows an address map 180 of the initiator node 160, which has a first portion 182 (i.e., local address portion) into which addresses for local resources are mapped and a second portion 184 (i.e., remote address portion) into which addresses for remote resources are mapped. Examples of local resources include, but are not limited to, local DRAM, on-chip resources, and CSRs. Examples of remote resources include, but are not limited to, remote DRAM, remote interrupts, and remote I/O's. In this manner, the address map 180 enables a remote memory region of a target node to be mapped into local address space on an initiator node.

An operation 210 is performed for assessing a target address specified in the bus transaction. For example, the on-chip bus switch 135 of the initiator node 160 can be configured for determining if the target address is or is not within the local address portion of the address map 180. If the target address is within the local address portion of the address map 180, the method continues to an operation 215 for steering the required resource of the initiator node 160 (e.g., the local memory controller in the case of a load bus transaction). Otherwise, when the target address is within the remote address portion of the address map 180, the method continues to an operation 218 for steering the bus transaction to the inter-node messaging module 145 of the initiator node 160 (e.g., a remote transaction engine thereof).

In response to the bus transaction being steered to the inter-node messaging module 145 of the initiator node 160, operations are performed for translating on-chip bus interface signals representing the bus transaction to one or more packets (e.g., a fabric read request packet) having a fabric-layer format (operation 220), for deriving a fabric global address derived from and corresponding to a target address specified in the bus transaction (operation 225), and imparting the one or more packets with the fabric global address (operation 230). Thereafter, the initiator node 160 performs an operation 235 for transmitting the one or more packets from the inter-node messaging module 145, through the fabric switch 150 and into the fabric 115 for reception by a node defined by the fabric global address (i.e., a target node 162). In the case where the on-chip bus of the initiator and target nodes 160, 162 are configured in accordance with AXI4 bus protocol, such transmission can be performed over a virtual AXI4 (i.e., on-chip) link within a fabric 115 between the initiator node 160 and the target node 162.

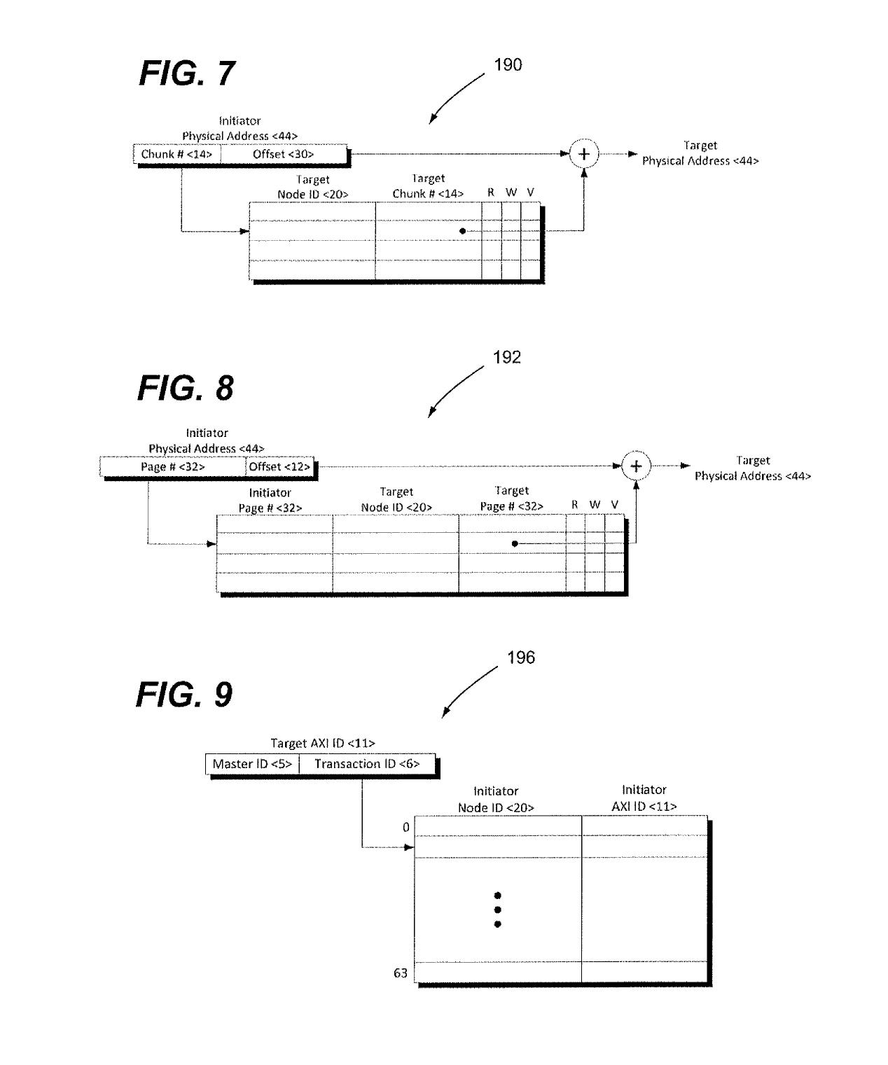

In one embodiment, the fabric global address is derived from the target address. FIG. 7 shows an example of an address look-up table for translating the target address to a target node identifier and target physical address in the case of address translation in relation to bus transactions for accesses to remote memory (i.e., a remote memory address look-up table 190). FIG. 8 shows an example of an address look-up table 192 for translating the target address to a target node identifier and target physical address in the case of accesses to remote I/O CSRs (i.e., a remote I/O address look-up table 192). DMA performed by a remote I/O controller (i.e., remote DMA can check both tables to see if the address hits in either of them. Each entry of the address look-up table 190 has permission bits of Read, Write, and Valid, as shown. Accordingly, imparting the one or more packets with the fabric global address can include instantiating the one or more packets with a resulting target node identifier and target physical address from an appropriate address look-up table. In certain embodiments, the address look-up tables are implemented within a remote transaction engine of the initiator node's inter-node messaging module.

In regard to the remote memory address look-up table 190, when an initiator node accesses mapped remote memory, the physical address associated with the access must be translated into a local physical address at the target node. This address translation provides protection and isolation between different initiator nodes when they access the same target node. The physical address associated with the remote memory access is logically partitioned into a Chunk# which identifies the mapped chunk in the physical address space that is being accessed and an Offset which identifies a location within that chunk. The Initiator Chunk# is used as an index into the address translation table. The lookup yields the Node ID of the associated target node and the target Chunk# at that target node. The combination of the target Chunk# and the Offset gives the physical address of the memory location on the target node that must be accessed. Each translation entry has a Valid (V) bit that must be set for every valid entry. The read enabled (R) bit indicates whether the initiator has read permission for the mapped chunk. The write enabled (W) bit indicates whether the initiator has write permission for the mapped chunk.

In regard to the a remote I/O address look-up table 192, when an initiator node accesses CSRs at I/O controllers of a target node, the physical address associated with the access must be translated into a local physical address at the target node. This address translation provides also ensures that the initiator node has the necessary permissions to access I/O controller CSRs at the target node. The address translation for disaggregated I/O maps remote 4 KB pages into the physical address space of a node. The physical address associated with the remote CSR access is logically partitioned into a Page# which identifies the mapped page and an Offset which identifies a location within that page. The translation table must be implemented as a CAM and the Page# is matched associatively against the Initiator Page # field in all rows. When a matching entry is found in the translation table, the Target Node ID identifies the target node and the Target Page # is concatenated with the Offset to determine the physical address of the accessed location at the remote node. Each translation table entry has a Valid (V) bit that must be set for each valid entry. The read enabled (R) bit indicates whether the initiator has read permission for the mapped location. The write enabled (W) bit indicates whether the initiator has write permission for the mapped location.

Referring to FIGS. 4 and 5, the fabric switch 150 of the target node 162 performs an operation 240 receiving the one or more packets transmitted from the initiator node 160 and providing the one or more packets to the inter-node messaging module 145 of the target node 162 (e.g., to a remote transaction engine thereof). The inter-node messaging module 145 of the target node 162 then performs an operation 245 for extracting the bus transaction from the one or more packets and an operation 250 for mapping a bus transaction identifier of the bus transaction to a respective local bus transaction identifier at the target node 162. Thereafter, the inter-node messaging module 145 of the target node 162 performs an operation 255 for issuing the bus transaction onto an on-chip bus master interface of the target node using the respective local bus transaction identifier. In this regard, the inter-node messaging module 145 of the target node 162 causes the bus transaction to be replayed/reproduced onto the on-chip bus master interface of the target node 162 (e.g., by manipulating the AXI signals within the AXI master interface 26 on the target node side of FIG. 2). Thereafter, an operation 260 is performed for steering the bus transaction to the cache coherent interconnect 130 of the target node 162, followed by an operation 265 for steering the bus transaction being to an appropriate local resource of the target node 162 (e.g., via the on-chip bus switch 135 and local memory controller 140 thereof).

In regard to mapping a bus transaction identifier of the bus transaction to a respective local bus transaction identifier at the target node 162, FIG. 9 shows the bus transaction identifier (e.g., AXI ID) mapping table 195 that is implemented by the inter-node messaging module 145 of the target node 162 to map between bus transaction identifiers at the initiator node 160 and the target node 162. For example, the bus transaction identifier mapping table 195 can be maintained by a remote transaction engine of the target node's inter-node messaging module 145. The target node uses the bus transaction identifier mapping table 195 to map an initiator node bus transaction identifier to a target node bus transaction identifier by allocating a row in the mapping table 195. If the mapping table is full, the incoming remote on-chip bus transaction can be held in a first-in-first-out (FIFO) buffer pending the completion of an earlier remote on-chip bus transaction.

After the initiator AXI ID is mapped to the target AXI ID through the remapping table, the incoming remote AXI transaction is reproduced on the CCN-504 interconect at the target node using the target AXI ID on the Messaging PM's AXI master interface. When an AXI slave device on the target node completes the transaction, the Transaction ID is used as an index to lookup the remapping table to determine the Node ID and AXI ID of the initiator. The Messaging PM then returns the read data and read response (in the case of a remote read) or the write response (in the case of a remote write) back to the initiator node with the initiator AXI ID. The read and write responses indicate whether the transactions completed successfully or had an error.

The bus transaction identifier Transaction ID is used to identify transactions from a master that may be completed out-of-order. For example, in the case of remote AXI transactions (i.e., a type of remote on-chip bus transaction), the ordering of remote AXI transactions at the target node is determined by the remote AXI masters on the initiator nodes. The messaging PM at the target node preferably does not impose additional ordering constraints that were not present at the initiator node. In addition, the messaging PM at the target node does not re-order transactions that were intended to be completed in order by the remote AXI masters. The ordering of the remote AXI transactions is maintained at the target node by allocating the target AXI ID (i.e., an bus transaction identifier for AXI transactions) in accordance with certain rules. A first one of these rules is that AXI transactions received from the initiator node with the same AXI ID must be allocated the same local AXI ID at the target node. A second one of these rules is that AXI transactions received from the initiator node with different AXI IDs must be allocated different local AXI IDs at the target node. A third one of these rules is that AXI transactions received from different initiator nodes must be allocated different local AXI IDs at the target node.

In support of remote transaction functionality, the Transaction Layer includes support for remote interrupts. Remote interrupts are implemented as message based interrupts. Each message is implemented as a remote memory write transaction. The address/data of the memory write transaction encodes the Node ID of the remote node, the interrupt vector, mode of delivery and other parameters.

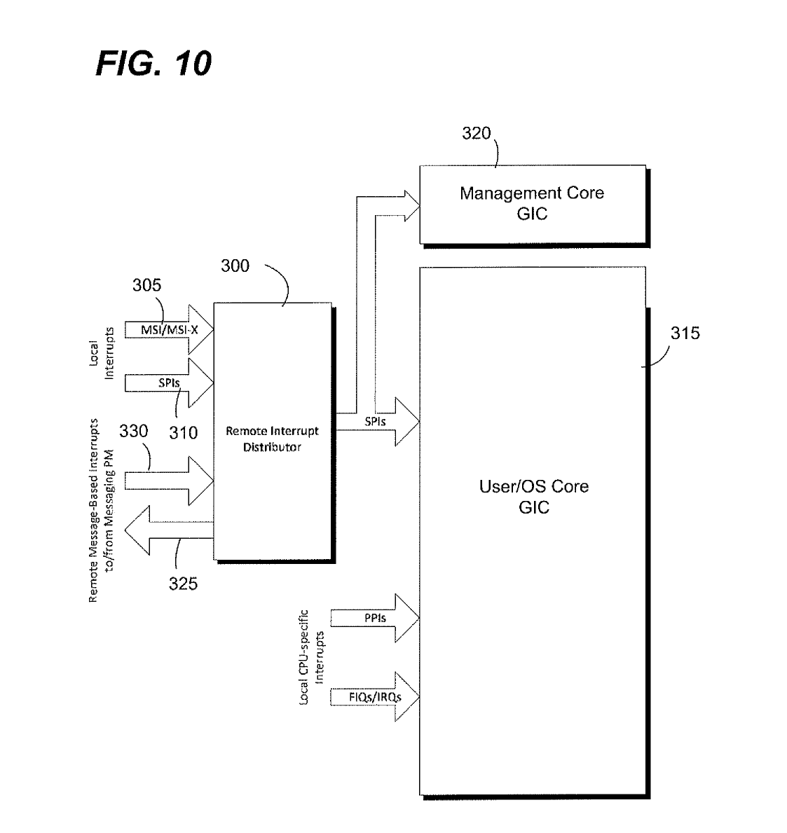

FIG. 10 shown an embodiment of a Remote Interrupt Distributor (RID) logic block 300 that provides remote interrupt controller functionality in accordance with an embodiment of the present invention. The RID logic block 300 is responsible for steering all interrupt sources within a SOC (e.g., the data processing node 100 discussed above in reference to FIG. 3). The RID logic block 300 can be programmed to generate remote software generated interrupts (SGIs). Remote SGIs enable a core (user/OS or management) on an initiator SoC (e.g., initiator node 160 discussed above in reference to FIG. 5) to issue an interrupt across a node interconnect fabric (i.e., a fabric) to a user/OS or management core on a target SoC (e.g., target node 162 discussed above in reference to FIG. 5).

The RID logic block 300 allows any interrupt source 305 (e.g., Message Signaled Interrupts (MSI)/Message Signaled Interrupts Extended (MSI-X) 305 or Shared Peripheral Interrupt (SPI) to be programmed to be either a local interrupt or a remote interrupt. Interrupt sources that are programmed as local are passed through the RID logic block 300 to the user core interrupt controller 315 or to the management cores interrupt controller 320. Interrupt sources that are programmed as remote generate messages (i.e., remote bus transaction messages) as above in reference to FIGS. 4 and 5. These messages are passed to the remote transaction protocol engine within a Messaging PM configured in accordance with an embodiment of the present invention (e.g., a portion of the inter-node messaging module 145 specifically configured for providing remote transaction functionality) through an outbound interrrupt message interface 325 of the RID logic block 300. Similarly, remote interrupt messages received at the messaging PM from a remote SoC node are passed from the messaging MP to the RID logic block 300 through an inbound interrrupt message interface 330 of the RID logic block 300.

In one embodiment, a remote interrupt functionality in accordance with an embodiment of the present invention can be as follows: a) a local I/O controller (e.g., SATA, PCIe, etc) on a local node SOC asserts an interrupt, b) the RID logic block of the local node generates a message corresponding to this interrupt (i.e., a bus transaction) and sends it to the messaging PM on the local node via the outbound interrrupt message interface thereof, c) the remote transaction protocol engine of the local node messaging PM sends the message to the target node as a remote memory write transaction using remote transaction functionality described above in reference to FIG. 4, d) the transaction is received by the remote transaction protocol engine of the messaging PM at the target node, e) the remote transaction protocol engine at the target node steers the message to the RID logic block at the target node via the inbound interrrupt message interface, f) the RID logic block at the target node generates a local SPI to the management core or user/OS core(s).

Remote interrupt memory write transactions are distinguished from other remote transactions by using a specific address range in the node's physical memory map. When the target node services the remote interrupt (i.e. a device driver on the target node services the remote interrupt), it can turn off the interrupt at the initiator node by performing a CSR write operation. The CSR write operation is also a remote transaction and is enabled by mapping the CSRs of the I/O controller on the initiator node that generated the interrupt into the physical address space of the target node.

Turning now to a general discussion on SoC nodes configured in accordance with embodiments of the present invention, a management engine of a SoC node is an example of a resource available in (e.g., an integral subsystem of) a SoC node of a cluster that has a minimal if not negligible impact on data processing performance of the CPU cores. For a respective SoC node, the management engine has the primary responsibilities of implementing Intelligent Platform Management Interface (IPMI) system management, dynamic power management, and fabric management (e.g., including one or more types of discovery functionalities). It is disclosed herein that a server on a chip is one implementation of a system on a chip and that a system on a chip configured in accordance with the present invention can have a similar architecture as a server on a chip (e.g., management engine, CPU cores, fabric switch, etc) but be configured for providing one or more functionalities other than server functionalities.

The management engine comprises one or more management processors and associated resources such as memory, operating system, SoC node management software stack, etc. The operating system and SoC node management software stack are examples of instructions that are accessible from non-transitory computer-readable memory allocated to/accessible by the one or more management processors and that are processible by the one or more management processors. A non-transitory computer-readable media comprises all computer-readable media (e.g., register memory, processor cache and RAM), with the sole exception being a transitory, propagating signal. Instructions for implementing embodiments of the present invention (e.g., functionalities, processes and/or operations associated with implementing on-chip bus transactions between SoC nodes) can be embodied as portion of the operating system, the SoC node management software stack, or other instructions accessible and processible by the one or more management processors of a SoC unit.

Each SoC node has a fabric management portion that implements interface functionalities between the SoC nodes. This fabric management portion is referred to herein as a fabric switch. In performing these interface functionalities, the fabric switch needs a routing table. The routing table is constructed when the system comprising the cluster of SoC nodes is powered on and is then maintained as elements of the fabric are added and deleted to the fabric. The routing table provides guidance to the fabric switch in regard to which link to take to deliver a packet to a given SoC node. In one embodiment of the present invention, the routing table is an array indexed by node ID.

In view of the disclosures made herein, a skilled person will appreciate that a system on a chip (SoC) refers to integration of one or more processors, one or more memory controllers, and one or more I/O controllers onto a single silicon chip. Furthermore, in view of the disclosures made herein, the skilled person will also appreciate that a SoC configured in accordance with the present invention can be specifically implemented in a manner to provide functionalities definitive of a server. In such implementations, a SoC in accordance with the present invention can be referred to as a server on a chip. In view of the disclosures made herein, the skilled person will appreciate that a server on a chip configured in accordance with the present invention can include a server memory subsystem, a server I/O controllers, and a server node interconnect. In one specific embodiment, this server on a chip will include a multi-core CPU, one or more memory controllers that support ECC, and one or more volume server I/O controllers that minimally include Ethernet and SATA controllers. The server on a chip can be structured as a plurality of interconnected subsystems, including a CPU subsystem, a peripherals subsystem, a system interconnect subsystem, and a management subsystem.

While the foregoing has been with reference to a particular embodiment of the invention, it will be appreciated by those skilled in the art that changes in this embodiment may be made without departing from the principles and spirit of the disclosure, the scope of which is defined by the appended claims.

What is claimed is:

1. An inter-node messaging module of a system on a chip (SoC) node, comprising:
an on-chip bus slave interface;
an on-chip bus master interface; and
a remote transaction engine coupled to the on-chip bus slave interface for enabling receipt of a bus transaction from a bus transaction initiator of the SoC node and to the on-chip bus master interface for enabling transmission of a bus transaction to a bus transaction target of the SoC node, wherein the remote transaction engine translates bus interface signals representing a bus transaction received on the on-chip bus slave interface to at least one packet having a fabric protocol format and imparts the at least one packet with a fabric global address derived from and corresponding to a target address specified in the bus transaction received on the on-chip bus slave interface.

2. The inter-node messaging module of claim 1, further comprising:
a node interconnect fabric interface;
wherein the remote transaction engine is coupled to the virtual link interface for enabling bus transactions to be transmitted to and received from at least one of a plurality of different SoC nodes via a node interconnect fabric connected to the node interconnect fabric interface;
wherein the remote transaction engine maps an initiator node bus transaction identifier of a bus transaction received on the node interconnect fabric interface to a respective target node bus transaction identifier and then issues the bus transaction received on the node interconnect fabric interface on the on-chip bus master interface using the respective target node bus transaction identifier.

3. The inter-node messaging module of claim 1, further comprising:
an address map having a first portion into which addresses for local resources are mapped and second portion into which addresses for remote resources are mapped; and
an on-chip bus switch for determining if a resource required by the bus transaction received on the on-chip bus slave interface is one of the local resources or is one of the remote resources;
wherein each one of the remote resources is that of a respective one of a plurality different SoC nodes;
wherein the on-chip bus switch causes the bus transaction to be received on the on-chip bus slave interface when the on-chip bus switch determines that the resource required thereby is one of the remote resources.

4. The inter-node messaging module of claim 1 wherein the bus transaction received on the on-chip bus slave interface is steered to the on-chip bus slave interface only when it is determined that a node resource required thereby is a resource of one of a plurality different SoC nodes.

5. The inter-node messaging module of claim 4, further comprising:
a node interconnect fabric interface;
wherein the remote transaction engine is coupled to the virtual link interface for enabling bus transactions to be transmitted to and received from at least one of the different SoC nodes via a node interconnect fabric connected to the node interconnect fabric interface;
wherein the remote transaction engine maps a initiator node bus transaction identifier of a bus transaction received on the node interconnect fabric interface to a respective target node bus transaction identifier and then issues the bus transaction received on the node interconnect fabric interface on the on-chip bus master interface using the respective target node bus transaction identifier.

6. The inter-node messaging module of claim 5, further comprising:
an address map having a first portion into which addresses for local resources are mapped and second portion into which addresses for remote resources are mapped; and
an on-chip bus switch for determining if a resource required by the bus transaction received on the on-chip bus slave interface is one of the local resources or is one of the remote resources;
wherein each one of the remote resources is that of a respective one of a plurality different SoC nodes;
wherein the on-chip bus slave interface being steered to the on-chip bus slave interface the on-chip bus switch is performed when the on-chip bus switch determines that the resource required thereby is one of the remote resources.

7. The inter-node messaging module of claim 5 wherein the bus transaction received on the node interconnect fabric interface being issued on the on the on-chip bus master interface includes the bus transaction received on the node interconnect fabric interface being derived from at least one packet having the fabric-layer format and includes a local physical address being determined based upon a fabric global address specified in the bus transaction received on the node interconnect fabric interface.

8. The inter-node messaging module of claim 5 wherein the remote transaction engine is inhibited from imposing any process order constraint on the bus transaction received on the node interconnect fabric interface that was not imposed thereon at a SoC node that initiated the bus transaction received on the node interconnect fabric interface.

9. The inter-node messaging module of claim 8 wherein the remote transaction engine being inhibited from imposing any process order constraint on the bus transaction received on the node interconnect fabric interface that was not imposed at a SoC node that initiated the bus transaction received on the node interconnect fabric interface includes:
the bus transaction received on the node interconnect fabric interface being mapped to a common target node bus transaction identifier as a different bus transaction received on the node interconnect fabric interface when the bus transaction received on the node interconnect fabric interface has the same initiator node bus transaction identifier as the different bus transaction; and
the bus transaction received on the node interconnect fabric interface being mapped to a unique target node bus transaction identifier than the different bus transaction when the bus transaction received on the node interconnect fabric interface has a different initiator node bus transaction identifier than the different bus transaction.

10. A method of implementing remote transactions between system on a chip (SoC) nodes of a node interconnect fabric, comprising:
determining that a bus transaction initiated at a first one of the SoC nodes specifies a target at a second one of the SoC nodes;
providing a virtual on-chip bus between the first and second SoC nodes within the fabric; and
providing the bus transaction to the second one of the SoC nodes over the virtual on-chip bus.

11. The method of claim 10 wherein providing the bus transaction to the second one of the SoC nodes over the virtual link on-chip bus includes:
translating bus interface signals representing the bus transaction at the first one of the SoC nodes to at least one packet having a fabric-layer format;
mapping a bus transaction identifier of the bus transaction to a respective local bus transaction identifier at the second one of the SoC nodes; and
issuing the bus transaction on an on-chip bus master interface of the second one of the SoC nodes using the respective local bus transaction identifier.

12. The method of claim 10 wherein providing the bus transaction to the second one of the SoC nodes over the virtual link on-chip bus includes:
receiving a bus transaction on the on-chip bus slave interface of a first one of the nodes when it is determined that the bus transaction specifies a target that is at a second one of the SoC nodes;
translating bus interface signals representing the bus transaction at the first one of the SoC nodes to at least one packet having a fabric-layer format;
imparting the at least one packet at the first one of the SoC nodes with a fabric global address derived from and corresponding to a target address specified in the bus transaction;
causing the at least one packet to be transmitted from the first one of the SoC nodes for reception by the second one of the SoC nodes;
extracting the bus transaction from the at least one packet after receiving the at least one packet at the second one of the SoC nodes;
mapping a bus transaction identifier of the bus transaction to a respective local bus transaction identifier at the second one of the SoC nodes; and
issuing the bus transaction on an on-chip bus master interface of the second one of the SoC nodes using the respective local bus transaction identifier.

13. The method of claim 12, further comprising:
mapping addresses for local resources into a first portion of an address map of the first one of the SoC nodes;
mapping addresses for remote resources into a second portion of the address map of the first one of the SoC nodes;
accessing the address map for determining if a resource required by the bus transaction received on the on-chip bus slave interface is one of the local resources or is one of the remote resources; and
causing the bus transaction to be received on the on-chip bus slave interface when the resource required thereby is in the second portion of the address map.

14. The method of claim 12 wherein the bus transaction received on the on-chip bus slave interface is steered to the on-chip bus slave interface only when it is determined that a node resource required thereby is a resource of one of a plurality different SoC nodes.

15. The method of claim 10, further comprising:
inhibited the second one of the SoC nodes from imposing any process order constraint on the bus transaction received thereby that was not imposed thereon at the first one of the SoC nodes.

16. The method of claim 15 wherein inhibited the second one of the SoC nodes from imposing any process order constraint on the bus transaction received thereby that was not imposed thereon at the first one of the SoC nodes includes:
mapping the bus transaction to a common target node bus transaction identifier as a different bus transaction received at the second on the SoC nodes over the virtual link on-chip bus when the bus transaction has the same initiator node bus transaction identifier as the different bus transaction; and
mapping the bus transaction to a unique target node bus transaction identifier with respect to the different bus transaction when the bus transaction has a different initiator node bus transaction identifier than the different bus transaction.

17. A system on a chip (SoC) node, comprising:
a cache coherent interconnect;
a bus transaction initiator coupled to the cache coherent interconnect;
a bus transaction target coupled to the cache coherent interconnect;
an on-chip bus switch connected to the cache coherent interconnect, wherein the on-chip bus switch determines if a target of a bus transaction issued from the bus transaction initiator is local to the SoC node or remote from the SoC node; and
an inter-node messaging module having an on-chip bus slave interface, an on-chip bus switch master interface, a node interconnect fabric interface and a remote transaction engine, wherein the on-chip bus slave interface and the on-chip bus switch master interface are each coupled between the on-chip bus switch and the remote transaction engine, wherein the remote transaction engine receives the bus transaction issued from the bus transaction initiator on the on-chip bus slave interface when the on-chip bus switch determines that the bus transaction issued from the bus transaction initiator has a target at a different SoC node, translates bus interface signals representing the bus transaction issued from the bus transaction initiator to at least one packet having a fabric-layer format and imparts the at least one packet with a fabric global address derived from and corresponding to a target address specified in the bus transaction issued from the bus transaction initiator and wherein the remote transaction engine maps a bus transaction identifier of a bus transaction received on the node interconnect fabric interface to a respective local bus transaction identifier and then issues the bus transaction received on the node interconnect fabric interface on the on-chip bus master interface using the respective local bus transaction identifier.

18. The SoC node of claim 17, further comprising:
an address map having a first portion into which addresses for local resources are mapped and second portion into which addresses for remote resources are mapped; and
an on-chip bus switch for determining if a resource required by the bus transaction received on the on-chip bus slave interface is one of the local resources or is one of the remote resources;
wherein each one of the remote resources is that of a respective one of a plurality different SoC nodes;
wherein the on-chip bus switch causes the bus transaction to be received on the on-chip bus slave interface when the on-chip bus switch determines that the resource required thereby is one of the remote resources.

19. The SoC node of claim 17 wherein the bus transaction received on the on-chip bus slave interface is steered to the on-chip bus slave interface only when it is determined that a node resource required thereby is a resource of one of a plurality different SoC nodes.

20. The SoC node of claim 17 wherein the bus transaction received on the node interconnect fabric interface being issued on the on the on-chip bus master interface includes the bus transaction received on the node interconnect fabric interface being derived from at least one packet having the fabric-layer format and includes a local physical address being determined based upon a fabric global address specified in the bus transaction received on the node interconnect fabric interface.

21. The SoC node of claim 17 wherein the remote transaction engine is inhibited from imposing any process order constraint on the bus transaction received on the node interconnect fabric interface that was not imposed thereon at a SoC node that initiated the bus transaction received on the node interconnect fabric interface.

22. The SoC node of claim 21 wherein the remote transaction engine being inhibited from imposing any process order constraint on the bus transaction received on the node interconnect fabric interface that was not imposed at a SoC node that initiated the bus transaction received on the node interconnect fabric interface includes:
the bus transaction received on the node interconnect fabric interface being mapped to a common target node bus transaction identifier as a different bus transaction received on the node interconnect fabric interface when the bus transaction received on the node interconnect fabric interface has the same initiator node bus transaction identifier as the different bus transaction; and
the bus transaction received on the node interconnect fabric interface being mapped to a unique target node bus transaction identifier than the different bus transaction when the bus transaction received on the node interconnect fabric interface has a different initiator node bus transaction identifier than the different bus transaction.

23. A data processing system, comprising:
a node interconnect fabric;
a first system on a chip (SoC) node including a first inter-node messaging module having an on-chip bus slave interface, a first node interconnect fabric interface and a first remote transaction engine, wherein the first SoC node is coupled to the node interconnect fabric through the first node interconnect fabric interface, wherein the first remote transaction engine receives a bus transaction on the on-chip bus slave interface when it is determined that the bus transaction specifies a target that is not local to the first SoC node, translates the bus interface signals representing the bus transaction to at least one packet having a fabric-layer format, imparts the at least one packet with a fabric global address derived from and corresponding to a target address specified in the bus transaction, and causes the at least one packet to be transmitted for reception by the target through the node interconnect fabric via the first node interconnect fabric interface; and
a second SoC node including a second inter-node messaging module having an on-chip bus switch master interface, a second node interconnect fabric interface and a second remote transaction engine, wherein the second SoC node includes the target specified in the bus transaction and is coupled to the node interconnect fabric through the second node interconnect fabric interface for allowing the at least one packet to be received by the second SoC node, wherein the second remote transaction engine extracts the bus transaction from the at least one packet, maps a bus transaction identifier of the bus transaction to a respective local bus transaction identifier and then issues the bus transaction on the on-chip bus master interface using the respective local bus transaction identifier.

24. The data processing system of claim 23 wherein the first SoC node further comprises:
an address map having a first portion into which addresses for local resources are mapped and second portion into which addresses for remote resources are mapped; and
an on-chip bus switch coupled for determining if a resource required by the bus transaction received on the on-chip bus slave interface is one of the local resources or is one of the remote resources;
wherein each one of the remote resources is that of a respective one of a plurality different SoC nodes;
wherein the on-chip bus switch causes the bus transaction to be received on the on-chip bus slave interface when the on-chip bus switch determines that the resource required thereby is one of the remote resources.

25. The data processing system of claim 23 wherein the bus transaction received on the on-chip bus slave interface is steered to the on-chip bus slave interface only when it is determined that a node resource required thereby is a resource of one of a plurality different SoC nodes.

26. The data processing system of claim 23 wherein the bus transaction received on the second node interconnect fabric interface being issued on the on the on-chip bus master interface includes the bus transaction received on the second node interconnect fabric interface being derived from at least one packet having the fabric-layer format and includes a local physical address being determined based upon a fabric global address specified in the bus transaction received on the second node interconnect fabric interface.

27. The data processing system of claim 23 wherein the remote transaction engine of the second SoC node is inhibited from imposing any process order constraint on the bus transaction received on the second node interconnect fabric interface that was not imposed thereon at the first SoC node.

28. The data processing system of claim 27 wherein the remote transaction engine of the second SoC node is being inhibited from imposing any process order constraint on the bus transaction received on the second node interconnect fabric interface that was not imposed thereon at the first SoC node includes:
the bus transaction received on the node interconnect fabric interface being mapped to a common target node bus transaction identifier as a different bus transaction received on the node interconnect fabric interface when the bus transaction received on the node interconnect fabric interface has the same initiator node bus transaction identifier as the different bus transaction; and
the bus transaction received on the node interconnect fabric interface being mapped to a unique target node bus transaction identifier than the different bus transaction when the bus transaction received on the node interconnect fabric interface has a different initiator node bus transaction identifier than the different bus transaction.
